(19) United States
(12) Patent Application Publication
(10) Pub. No.: US 2026/0116677 A1
(43) Pub. Date: Apr. 30, 2026

(54) PNEUMATIC CONVEYER SYSTEM FOR APPLICATION OF COSMETIC COMPOSITIONS

(71) Applicant: L'Oreal, Paris (FR)

(72) Inventors: Ayoub Hbaich, Franklin Park, NJ (US); Rafael Feliciano, New Providence, NJ (US)

(73) Assignee: L'Oreal, Paris (FR)

(21) Appl. No.: 18/930,280

(22) Filed: Oct. 29, 2024

(51) Int. Cl. B65G 51/02; B01F 23/30; B01F 25/312; B01F 101/21

(52) U.S. Cl. CPC B65G 51/02; B01F 25/312; B01F 23/39; B01F 2101/21

(57) ABSTRACT

Pneumatic conveyer systems, and formulation delivery devices and systems that include the pneumatic conveyer systems. A pneumatic conveyer system is configured for controlled conveyance and mixture of a plurality of formulations that includes at least one non-fluid formulation, such as a solid, powder, and/or salt, to produce a resultant formulation. The pneumatic conveyer system includes a Venturi channel that conveys pressurized air which produces a vacuum that draws the formulations into the Venturi channel, where they are mixed, and also includes an air separator configured for separation of air from the air-formulation mixture. Formulation delivery devices and systems mix and dispense the resultant formulation for application of the formulation to hair and/or skin of an individual.

### SUMMARY

In an aspect, the disclosure provides a pneumatic conveyer system configured for controlled mixture and conveyance of a plurality of formulations that comprises a non-fluid formulation, the pneumatic conveyer system comprising: an air compressor configured to intake air and pump pressurized air into a Venturi channel; a plurality of formulation conduits that are fluidically connectable to the plurality of formulations and are fluidically connected to the Venturi channel, wherein connection of the plurality of formulation conduits to the plurality of formulations and passage of air from the air compressor into the Venturi channel draws the plurality of formulations into the Venturi channel such that the non-fluid formulation is mixed with a fluid formulation and the air to form an aerated mixture; and an air separator configured to degas the aerated mixture to form a non-aerated mixture and convey the non-aerated mixture therefrom.

In embodiments, the air compressor intakes environmental air through an intake vent and wherein the air separator exhausts air through an exhaust vent, and the air compressor pumps pressurized air into the Venturi channel by way of an air conduit.

In embodiments, the air separator is a cyclone air separator configured to separate air from the aerated mixture by way of vortex separation.

In embodiments, the pneumatic conveyer system further comprises a plurality of dampers operably connected to control circuitry and configured for control of flow of the plurality of formulations therethrough for production of the aerated mixture from the plurality of formulations based on a mix ratio for the plurality of formulations.

In embodiments, the control circuitry is configured to receive one or more signals from one or more formulation cartridges that corresponds to one or more formulations of the plurality of formulations, and compute the mix ratio based on the one or more signals.

In embodiments, the mix ratio defines a relative amount of the non-fluid formulation to be mixed with a relative amount of the fluid formulation to form the aerated mixture.

In embodiments, the non-fluid formulation is a powder.

In embodiments, the powder and the fluid formulation are components of a hair bleach composition for bleaching hair of an individual.

In embodiments, the air separator conveys the non-aerated mixture to a formulation mixer that mixes and homogenizes the non-aerated mixture, and is configured to dispense a resultant formulation through a reciprocating nozzle assembly to be applied to hair of an individual.

In embodiments, the formulation mixer is a turbulent mixing chamber that comprises one or more helical mixers positioned within a fluidic pathway and configured to carry, mix, and homogenize the non-aerated mixture to produce the resultant formulation.

In embodiments, the reciprocating nozzle assembly comprises a plurality of nozzles and is driven by a motor, such that the plurality of nozzles reciprocate back-and-forth along a track while dispensing the resultant formulation.

In embodiments, the passage of air from the air compressor into the Venturi channel produces a vacuum that draws at least a portion of the plurality of formulations into the Venturi channel based on configurations of a plurality of dampers configured for control of flow of the plurality of formulations therethrough.

In embodiments, the Venturi channel comprises an air conduit at a central portion thereof, a first formulation conduit at a first portion thereof configured to carry a first formulation of the plurality of formulations, and a second formulation conduit at a second portion thereof configured to carry a second formulation of the plurality of formulations, wherein the central portion is positioned between the first portion and second portion.

In embodiments, a first damper is positioned inline with the first formulation conduit and a second damper is positioned inline with the second formulation conduit, wherein the first damper and second damper are positioned upstream of the air separator.

In an aspect, the disclosure provides a formulation delivery device or formulation delivery system comprising the pneumatic conveyer system.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 shows a schematic view of an example formulation delivery system, according to aspects of the disclosure.

FIG. 2 shows a rear perspective view of an example formulation cartridge, according to aspects of the disclosure.

FIG. 3 shows a side cutaway view of the example formulation delivery system with pneumatic conveyer system therein, according to aspects of the disclosure.

FIG. 4 shows a top cross-sectional view of an example Venturi channel with formulation and air conduits, according to aspects of the disclosure. Dotted arrow lines indicate flow of air, while solid arrow lines indicate flow of formula.

TABLE 1
Drawings elements and descriptions.

| Reference | Description |
|---|---|
| 100 | Formulation delivery system |
| 102 | Formulation product line |
| 104 | Formulation delivery device |
| 106 | Formulation |
| 108 | Formulation cartridge |
| 200 | Formulation cartridge |
| 202 | Handle portion |
| 203 | First half |
| 204 | Second half |
| 206 | Reservoir |
| 208 | Output nozzles |
| 210 | Front body portion |
| 212 | Refill unit |
| 300 | Pneumatic conveyer system |
| 301 | Intake vent |
| 302 | Formulation cartridge port |
| 303a | Formulation conduit (first) |
| 303b | Formulation conduit (second) |
| 304 | Air compressor |
| 305 | Air conduit |
| 306a | Damper (first) |
| 306b | Damper (second) |
| 307 | Venturi channel |
| 308 | Air-formulation (aerated mixture) conduit |
| 309 | Cyclone air separator |
| 310 | Separated air conduit |
| 311 | Exhaust vent |
| 312 | De-gassed formulation (non-aerated mixture) conduit |
| 313 | Formulation (non-aerated mixture) mixer |
| 414 | Reciprocating nozzle assembly |
| 416 | Plurality of standoff portions |

The foregoing aspects and many of the attendant advantages of this disclosure will become more readily appreciated as the same become better understood by reference to the following detailed description, when taken in conjunction with the accompanying drawings.

### DETAILED DESCRIPTION

Preparation of at least some hair formulations can include mixture of a non-fluid formulation, such as a solid, salt, or powder, with at least one fluid formulation. Using approaches as disclosed herein, haircare fluid formulation systems and devices, such as the Colorsonic™ device as commercially provided by L′Oréal as a non-limiting example, can be advantageously configured for mixture of one or more non-fluid formulations to generate ready-to-apply hair formulations. The disclosed approaches are able to mix and convey non-fluid formulations in combination with fluid formulations through the use of structures that make practical implementation of the Venturi effect, a reduction in fluid pressure that results when a moving fluid speeds up as it flows through a constricted section (or choke) of a pipe or tubing. The disclosed approaches also enhance formulation delivery systems that include one or more solids, such as salts, or powders, as at least one component of a hair formulation, including by way of a non-limiting example, hair bleach formulations.

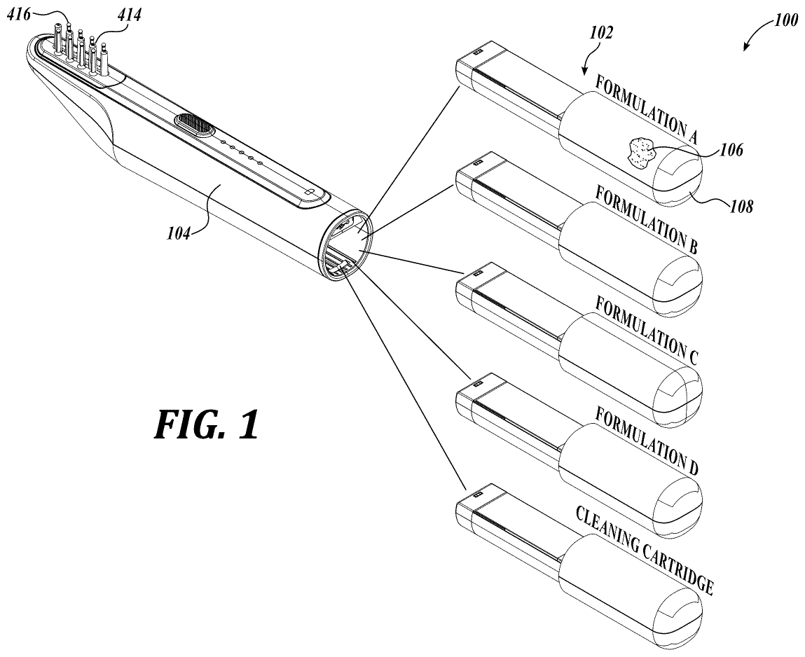

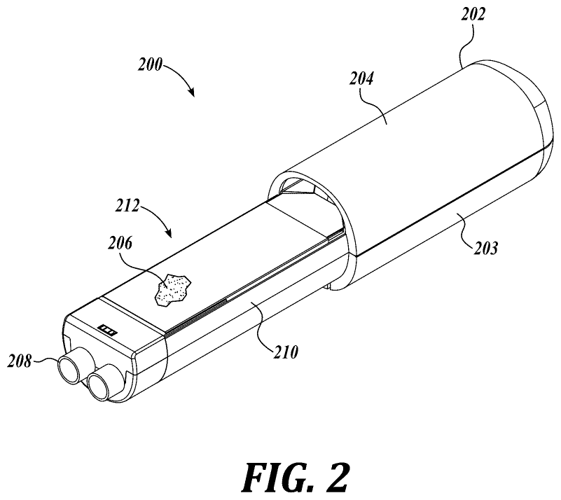

A formulation delivery system can be configured for compatible use with any of a plurality of formulation cartridges. By way of a non-limiting example, FIG. 1 shows a side perspective view of an example formulation delivery system, and FIG. 2 shows a rear perspective view of an example formulation cartridge. A formulation delivery system 100 can include a formulation cartridge 200. The shown formulation delivery system 100 is an example of a formulation delivery system as described in detail in U.S. Patent Application Publication No. US20240172858A1, published May 30, 2024, and assigned to L′Oreal, which is incorporated by reference herein in its entirety for all purposes. However, it is to be understood that aspects and embodiments of the present disclosure can be used with any formulation delivery system for hair coloring and/or hair bleaching, without departing from the scope and spirit of the disclosure.

The shown example formulation delivery system 100 includes a formulation product line 102, a formulation delivery device 104, and a formulation 106 (e.g., within a liquid reservoir 206 of a formulation cartridge 108, shown as a cutaway view within FIGS. 1-2), which together enable application of a cosmetic composition to the hair of an individual for a personalized hair treatment experience, such as hair coloring and/or bleaching. Formulation product line 102 includes formulation cartridges 108, and formulation cartridges 108 can be of a same (or common) cartridge type configured for interchange and use with the formulation delivery device 104.

The formulation product line 102 can include a cosmetic composition as a hair bleaching formulation, which can include a bleach formula and a developer formula which, when mixed together by the formulation delivery device 104, form the cosmetic composition to be applied to the hair of an individual. In embodiments, a formulation product line 102 can comprise one or more cartridges that comprise: a bleach formula and a developer, a permanent hair dye and a developer, a semi-permanent hair dye and a developer, a shampoo, a conditioner, a hair growth treatment such as minoxidil, a hair protein treatment, a disulfide bond repairing hair treatment, a fluid scalp treatment, or the like.

In embodiments, a formulation product line 102 can include a cleaning cartridge comprising a cleaning solution therein for cleaning the formulation delivery device 104 before and/or after use. A cleaning solution can enable an individual to clean the formulation delivery device 104 by executing a cleaning routine, with the device and the cleaning solution cartridge, that flushes a cleaning liquid (e.g., water, saline) from the cleaning cartridge through fluid conduits of the formulation delivery device 104. This removes residual formulation from the formulation delivery device 104. Advantageously, the cleaning cartridge and cleaning routine enable a significant portion of the formulation delivery device 104 to be reused for different formulations, thereby reducing waste and cost. The cleaning cartridge can include a refillable cleaning liquid reservoir disposed inside the outer housing, which is fluidically connected to the plurality of output nozzles. Thus, a user can fill the cleaning liquid reservoir with a cleaning liquid such as water, execute a number of cleaning routines on the formulation delivery device 104, and refill the cleaning liquid reservoir.

The shown formulation cartridge 108 has an elongate shape and dimensions configured for insertion into a handle of the formulation delivery device 104, in particular into a cartridge cavity of the handle, for mixing and dispensing the cosmetic composition from the formulation delivery device 104. All or substantial portions of a formulation cartridge 108 can be comprised of one or more recyclable elements, for example, for managing the environmental impact of the system and product line.

The formulation cartridge 108 can comprise a plurality of liquid output nozzles, which are sized and positioned at a distal (forward) end of the formulation cartridge 108 in a configuration that fluidically connects with a corresponding plurality of liquid inlets (e.g., first formulation inlets) of the formulation delivery device 104. In embodiments, the liquid output nozzles are valves of formulation vessels (e.g., pouches or packets) disposed in formulation cartridge 108.

FIG. 2 shows a formulation cartridge 200 which is compatible with any of the formulation delivery systems, formulation delivery devices, and formulation product lines described herein. However, the formulation delivery systems, formulation delivery devices, and formulation product lines described herein are not necessarily required to use the sustainable formulation cartridge 200 shown in FIG. 2.

In embodiments, the formulation cartridge 200 is sustainable and is designed to reduce waste and environmental impact, while delivering a user-friendly experience. It includes two main components: a handle portion 202 and a disposable formulation cartridge refill unit 212 (hereinafter referred to simply as refill unit 212) configured to reversibly slide into the handle portion 202. The formulation cartridge 200 is constructed such that the handle portion 202 can be reused indefinitely and the refill units 212 can be readily replaced after depletion of the formulation stored therein. Furthermore, refill unit 212 can be configured to be deconstructed into smaller components, at least some of which can be recycled in embodiments, and others disposed of. Thus, the formulation cartridge 200 utilizes an innovative structure to reduce waste and improve the user experience.

In embodiments, handle portion 202 is sized, dimensioned, and constructed to be repeatedly inserted into the cartridge cavity of the formulation delivery device. Accordingly, handle portion 202 can be formed of a plastic or similar rigid polymer or other material and includes a hollow handle portion 202 configured to receive the refill unit 212 therein. Refill unit 212 includes a refill packet comprising a shell enclosing at least one formulation vessel (e.g., a packet, pouch, or other vessel), for example a first formulation pouch and a second formulation pouch, and a valve frame coupled with the refill packet, e.g., a front body portion 210. In embodiments, at least one formulation vessel is a liquid reservoir 206. The first formulation pouch and second formulation pouch can contain a first formulation (e.g., bleach formula) and a second formulation (e.g., developer formula), respectively. The refill unit 212 can include a packet sleeve. In embodiments, a formulation vessel can comprise a formulation packet and an output nozzle.

In embodiments, the first formulation pouch and second formulation pouch, of the formulation cartridge 200, can each have a volume of about 40 mL to about 70 mL, about 50 mL to about 60 mL, about 40 mL to about 65 mL, about 40 mL to about 60 mL, about 40 mL to about 55 mL, about 40 mL to about 50 mL, about 45 mL to about 70 mL, about 50 mL to about 70 mL, about 55 mL to about 70 mL, about 60 mL to about 70 mL, or about 55 mL. In embodiments, first and second formulation pouches can have different volumes. In embodiments, refill unit 212 stores only one formulation vessel.

In embodiments, the first formulation and second formulation can be independently selected from any of the formulations described herein, or their equivalents in the art, and can include at least one non-fluid formulation, for example, a bleach formula, a permanent hair dye, a semi-permanent hair dye, a developer formula, a conditioner, a hair growth treatment such as minoxidil, a hair protein treatment, a disulfide bond repairing hair treatment, a fluid hair treatment, a fluid scalp treatment, and any combination thereof, or the like. In embodiments, the first formulation and second formulation differ. For example, in some embodiments, the first formulation is a bleach formula and the second formulation is a developer. In other embodiments, the first formulation and second formulation are the same (e.g., a conditioner or scalp treatment formulation).

In embodiments, formulation pouches include a formulation-containing packet and valve means comprising output nozzles 208 for selectively-fluidic coupling the refill unit to a dispensing nozzle unit of a formulation delivery device when the formulation cartridge 200 is received within the hand-held formulation dispensing device. Representative valve means include a valve through which the formulation exits the formulation-containing packet. Example formulation vessels are described in International Patent Application Publication No. WO2019067336A2, published Apr. 4, 2019, and assigned to L′Oreal S A, and U.S. Patent Application Publication No. US20210196021A1, published Jul. 1, 2021, and assigned to L′Oreal S A, both of which are hereby incorporated by reference in their entireties for all purposes.

In embodiments, the shell (i.e., outer portion) of the cartridge refill unit 212 has an elongate shape sized to be received within the reusable handle portion 202. The shell encloses and protects the first formulation pouch and second formulation pouch and engages the valve frame (described below). Thus, the shell functions as packaging which protects the formulation pouches during commerce prior to loading into the formulation delivery device.

In embodiments, the shell has a total length between 150 and 250 mm (e.g., 175-225 mm, 185-215 mm, 195-205 mm, or 200 mm) and a maximum cross-sectional dimension of 25-50 mm (e.g., 30-45 mm, 35-40 mm, or 36 mm). The shell has a rear body portion and a slender front body portion 210, e.g., a neck portion, extending away from the body portion. The body portion and the slender front body portion 210 generally align in a common longitudinal direction to enable assembly with the reusable handle portion 202, and to enable insertion into the cartridge cavity of the formulation delivery device. In embodiments, the shell is constructed at least partially from a recyclable or recycled material, e.g., a paper material such as an injection-molded paper material or a die-cut structured paper (e.g., cardboard). In embodiments, the shell is formed from a single piece of injection-molded paper material. In embodiments in which the shell is formed of paper, the paper has a weight between 8-12 points (e.g., 8.5 points, 9.0 points, 9.5 points, 10.0 points, 10.5 points, 11.0 points, or 11.5 points), to impart sufficient stiffness without contributing excess disposable material.

In embodiments, the rear body portion of the shell has a larger cross-sectional dimension than the front body portion 210 when viewed in a plane normal to the longitudinal direction of the formulation cartridge 200. A hump or bulge imparts the larger cross-sectional area of the rear body portion relative to the slender front body portion 210. Advantageously, the hump or bulge enables the use of higher-volume formulation pouches. Additionally, the hump or bulge forms an abutment which abuts a corresponding interior face of the handle portion 202 and secures the longitudinal position of the shell during use, for example, by friction fit.

In embodiments, the slender front body portion 210 of the shell is sized to fit within the handle portion 202 and to project into the cartridge cavity of the formulation delivery device during use. The front body portion 210 couples with the valve frame. To facilitate secure connection and alignment with the valve frame, the front body portion 210 includes valve frame coupling means, for example at least one coupling tab configured to selectively engage the valve frame. In the illustrated embodiment, the front body portion 210 includes a single coupling tab extending away from a front end thereof. The coupling tab includes an engagement feature, for example a detent or raised prominence shaped and sized to engage a complementary aperture of the valve frame.

In embodiments, the shell can have any of various different configurations. For example, the shell can be a clamshell configuration formed with at least two partial shells (in this embodiment, first half 203 and second half 204) hingedly coupled. In embodiments, the shell includes a different number of partial shells, e.g., three or four partial shells which come together to enclose the formulation pouches. In still other embodiments, the shell comprises a single piece forming an open-ended tube into which the formulation pouches can be inserted. Alignment of the first half 203 and second half 204 enables correct attachment of the front body portion 210 to the valve frame.

While the illustrated shell is formed of an injection molded paper material, this construction is an example and is not limiting. In embodiments, the shell is formed of a single piece of die-cut paper stock, which is folded to impart a three-dimensional structure having the rear body portion and slender front body portion 210 extending away therefrom. In embodiments, this folded construction creates a polygonal cross section in the rear body portion and a polygonal cross section in the front body portion 210 (for example, octagonal and hexagonal cross sections, respectively). To facilitate assembly, embodiments of the shell include one or more scores or guidelines that ensure correct folding. Embodiments have a triangular, rectangular, pentagonal, hexagonal, heptagonal, octagonal, or other polygonal cross-sectional shape.

In embodiments, a packet sleeve can slide over the front body portion 210 and provide several important advantages. First, it imparts additional structure to the refill unit 212 by sliding over and reinforcing front body portion 210. Accordingly, in embodiments, packet sleeve has a greater weight or thickness as compared to the material that forms the shell; although this is not required. In embodiments, packet sleeve is formed of a recyclable material, which can be the same material as the shell. In embodiments, packet sleeve couples with the valve frame. For example, the packet sleeve can include a plurality of engagement member recesses configured to reversibly couple with engagement members of the valve frame. The packet sleeve can facilitate disassembly of the refill unit 212.

In embodiments, the valve frame provides a rigid structure which aligns the output nozzles 208 for correct fluid interconnection with the fluid conduits of the formulation delivery device. Accordingly, the valve frame can be formed from ABS plastic, HDPE, or another rigid polymer or other material. In embodiments, the valve frame is formed from a same material as the shell. Thus, the shell, formulation pouches, valve frame, and optional packet sleeve form the refill unit 212. In use, refill unit 212 is reversibly couplable with handle portion 202, e.g., by securing means such as coupling tabs on the shell or by friction fit between the refill unit 212 and the handle portion 202.

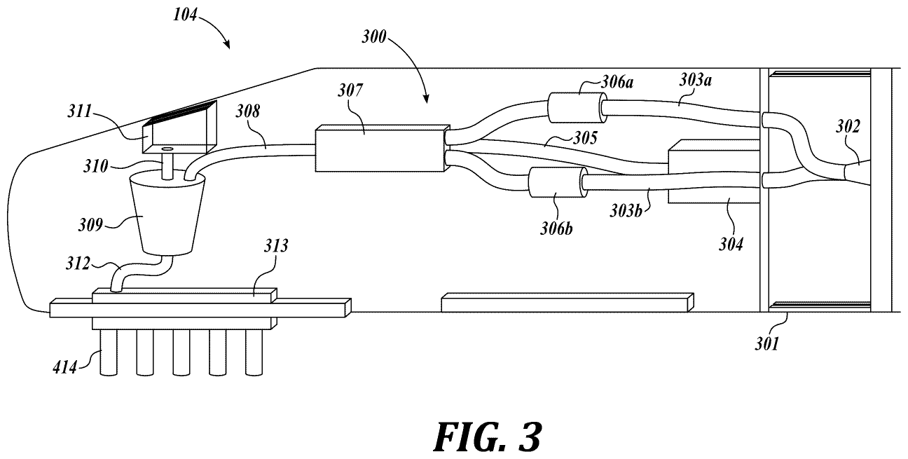

As shown at FIG. 3, an example formulation delivery device 104 with pneumatic conveyer system 300 therein is configured for controlled mixture and conveyance of a plurality of formulations that comprises a non-fluid formulation. A pneumatic conveyer system 300 includes an air compressor 304 that is configured to intake air (e.g., from an intake vent 301) and pump pressurized air into a Venturi channel 307 (e.g., via an air conduit 305), a plurality of formulation conduits (e.g., first and second formulation conduits 303a, 303b) that are fluidically connectable to the plurality of formulations and are fluidically connected to the Venturi channel 307. Connection of the plurality of formulation conduits 303a, 303b to the plurality of formulations (e.g., via connection to output nozzles 208 of FIG. 2), and passage of air from the air compressor 304 into the Venturi channel 307, draws the plurality of formulations from the cartridges through the formulation cartridge port 302 and into the Venturi channel 307, such that the non-fluid formulation is mixed with a fluid formulation and the air within the Venturi channel 307 to form an aerated mixture. An air separator (e.g., a cyclone air separator 309) degases the aerated mixture to form a non-aerated mixture and conveys the non-aerated mixture therefrom into a formulation mixer 313 by way of passage of the non-aerated mixture through a de-gassed formulation conduit 312.

After degassing the mixture to form the non-aerated mixture, the non-aerated mixture may not be completely homogenized, and may benefit from further mixing by the formulation mixer 313. As such, the formulation mixer 313 mixes and homogenizes the non-aerated mixture, and dispenses a resultant formulation through a reciprocating nozzle assembly 414 wherefrom it is expelled and applied to hair of an individual. In the shown embodiment, the formulation mixer 313 is a turbulent mixing chamber that comprises one or more helical mixers positioned within a fluidic pathway, and carries, mixes, and homogenizes the non-aerated mixture to produce the resultant formulation. However, other types of formulation mixers can be implemented without departing from the scope and spirit of the disclosure. In the shown embodiment, the reciprocating nozzle assembly 414 comprises a plurality of nozzles (e.g., spaced apart and separated by a plurality of standoff portions 416), and is driven by a motor, such that the plurality of nozzles reciprocate back-and-forth along a track while dispensing the resultant formulation; however, alternate nozzle assembly designs can be implemented without departing from the scope and spirit of the disclosure.

Operation of the Venturi channel 307 to form a Venturi effect relies on the movement of air through the system for creation of a vacuum force that moves the formulas from the cartridges through the formulation delivery device 104 for mixture and expulsion. During operation of the shown embodiment, the air compressor 304 intakes environmental air through the intake vent 301 and the cyclone air separator 309 exhausts air through an exhaust vent 311, and the air compressor 304 pumps pressurized air into the Venturi channel 307 by way of the air conduit 305, however, alternate configurations can be implemented for air movement without departing from the scope and spirit of the disclosure.

In the shown embodiment, the passage of air from the air compressor 304 into the Venturi channel 307 produces a vacuum that draws at least a portion of the plurality of formulations into the Venturi channel 307 based on configurations (e.g., open, degree of openness, closed) of a plurality of dampers (e.g., dampers 306a, 306b) configured for control of flow of the plurality of formulations therethrough. The disclosed example design, including with use of the Venturi channel 307, enables high-strength vacuum forces to be generated that quickly and efficiently move and mix solids and liquids within the device for being applied to the hair. The Venturi effect produced by the Venturi channel 307 is particularly advantageous compared to other approaches, such as pumps, for the movement of non-fluid formulations through the device. With use of the Venturi channel 307, the number of moving mechanical parts that interact with the non-fluid formulation is limited, which prevents the internal tubing of the device from becoming clogged by the presence of solids or powder clumps. As a result, the device can reliably operate for longer periods, without the need for high-frequency regular cleaning and maintenance, as would be expected to be the case with peristaltic pump designs.

Since the Venturi channel 307 mixes a non-fluid formula with a fluid formula using movement of air, the mixed formulas can produce an aerated mixture that can be advantageously degassed prior to being applied to the hair. Accordingly, an air separator can be included. In the shown embodiment, the air separator is a cyclone air separator 309 that is configured to separate air from the aerated mixture by way of vortex separation, and drain the non-aerated mixture into the de-gassed formulation conduit 312 by the force of gravity. However, other types of air separators can be implemented for degassing the aerated mixture, including embodiments operable without the need for the force of gravity for movement of the de-gassed formulation, without departing from the scope and spirit of the disclosure.

Control of a mix ratio between the non-fluid formulation and the fluid formulation can advantageously contribute to various properties of the resultant cosmetic composition, such as potency and, as a result, the time needed to apply the composition to the hair to achieve a desired effect. Accordingly, in embodiments, the pneumatic conveyer system 300 further comprises a plurality of dampers (e.g., first and second dampers 306a, 306b), positioned inline with the formulation conduits 303a, 303b and upstream of the Venturi channel 307 and the cyclone air separator 309, that are operably connected to control circuitry and configured for control of flow of the plurality of formulations therethrough for production of the aerated mixture from the plurality of formulations based on a mix ratio for the plurality of formulations. The control circuitry can electronically control operation and configuration of the dampers 306a, 306b, such as by way of an electric motor and/or actuator, to open and/or close the dampers 306a, 306b to allow a defined amount of a first formulation through the first damper 306a and to allow a defined amount of a second formulation through the second damper 306b. In this manner, the mix ratio can define a relative amount of the non-fluid formulation to be mixed with a relative amount of the fluid formulation to form the aerated mixture. Non-limiting examples of dampers that can be used for dampers 306a, 306b include, but are not limited to, one or more rotary butterfly valves, one or more ball valves, one or more needle valves, one or more pinch valves, one or more sliding gate valves, one or more diaphragm valves, one or more check valves, one or more solenoid valves, and any combination thereof.

Control circuitry of the formulation delivery device 104 can be configured based on a software application, executed by at least one process of the formulation delivery device 104 or another computational device, such as a smartphone, that defines relative amounts of two or more formulas to be mixed for a particular hair treatment. Accordingly, in embodiments, the control circuitry is configured to receive one or more signals from one or more formulation cartridges that corresponds to one or more formulations of the plurality of formulations, and compute the mix ratio based on the one or more signals. The signals can be received by the circuitry by way of any connection with the formulation cartridges, including but not limited to a wired connection, or a wireless connection, such as a wireless query of a radiofrequency identification (RFID) chip of a formulation cartridge, for example.

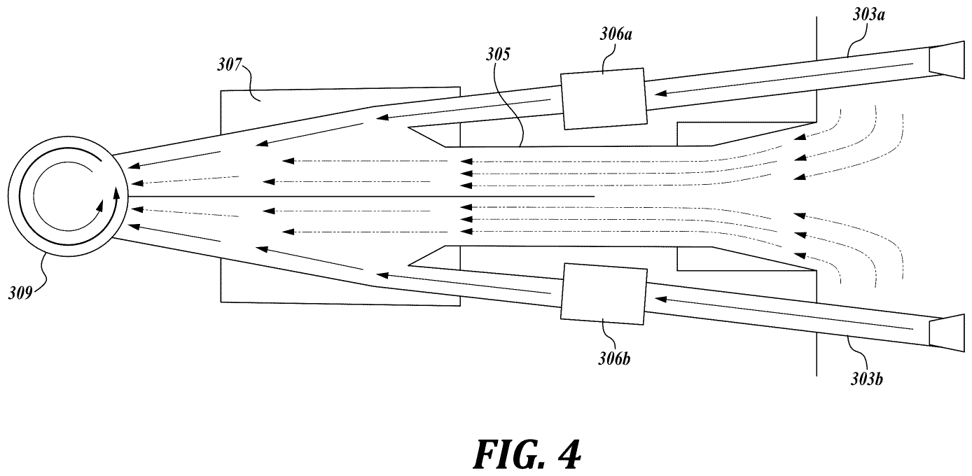

As shown at FIG. 4, the Venturi channel 307 comprises an air conduit 305 at a central portion thereof, the first formulation conduit 303a at a first portion thereof configured to carry a first formulation of the plurality of formulations, and a second formulation conduit 303b at a second portion thereof configured to carry a second formulation of the plurality of formulations. The central portion is positioned between the first portion and second portion. As the air (dotted arrows) flows through the central portion, it creates a vacuum force that pulls formulas from the first and second portions where they are mixed with the air and the aerated mixture conveyed into a cyclone air separator 309. Depending on the configuration of the dampers 306a, 306b, the vacuum force at the formulation conduits 303a, 303b may be greater or lesser, resulting in increased or decreased flow of formulation therethrough for control of the mix ratio between the at least two formulations. Since the air moves at a relatively high rate, the formula and mixture do not become overly stuck within the device or the Venturi channel 307, and cleaning and maintenance does not need to occur as frequently.

In an aspect, the disclosure provides a formulation delivery device or formulation delivery system comprising the pneumatic conveyer system. While an example of a formulation delivery device 104 and system 100 are shown at FIG. 1, alternate designs and configurations that implement the pneumatic conveyer system can be implemented without departing from the scope and spirit of the disclosure. In addition, while an example of a pneumatic conveyer system 300 is shown at FIG. 3, alternate designs and configurations of the pneumatic conveyer system can be implemented without departing from the scope and spirit of the disclosure.

In the claims and for purposes of the present disclosure, the terms “a”, “an”, “the”, and the like, refer to the singular and the plural forms of the object or element referenced.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

As used herein, “system” and “computational system” refer to one or more computational devices that are configured for performing all or part of any method of the disclosure, in any order or sequence of steps, optionally in combination with one or more other computational devices that are configured for performing all or part of any method of the disclosure, in any order or sequence of steps. In at least some instances, a method can be performed by two or more computational devices that together form at least part of a computational system, and in such instances, the steps carried out by a first computational device can be complementary to the steps carried out by a second computational device. In other instances, a method can be performed by one computational device that forms at least part of a computational system.

As used herein, “computational device” refers to a physical hardware computing device that is configured for performing all or part of any method of the disclosure, in any order or sequence of steps, optionally with human input. In embodiments, circuitry of such a computational device is configurable with a processor and processor-executable instructions stored on a non-transitory machine-readable medium of the computational device, as a non-limiting example, but other approaches for configuring circuitry of the computational device can be implemented in embodiments. In embodiments, the computational device includes a processor for execution of instructions stored on a non-transitory machine-readable medium, for enabling the processor to carry out all or part of a method or process of the disclosure. Accordingly, in embodiments, a computational device includes a software application configured to perform all or part of one or more methods or processes of the disclosure, in any order or combination. However, in embodiments, a computational device includes dedicated hardware circuitry. Further configuration of circuitry of the computational device can include networking circuitry, for example, circuitry configured for a wireless connection, such as a Bluetooth® connection, a Bluetooth® low energy (BLE) connection, and/or a Wi-Fi® connection, and/or a wired connection. The networking circuitry, in combination with circuitry of the computational device, can be used to request, retrieve, and/or receive data from a remote server, for example. In embodiments, the circuitry can include operable connection of one or more sensors with the processor, or other circuitry, for performing logic operations and/or methods based on data received from the one or more sensors, for example.

While various types of computational devices useful for systems of the disclosure are discussed herein or are otherwise envisioned, an example computational device can be implemented as a device on a network. Examples can include servers, personal computers, mobile phones, smart phones, tablet computers, embedded computational devices, and other devices that can be used to implement portions of embodiments of the present disclosure. Embodiments of a computational device can be implemented in or can include an application-specific integrated circuit (ASIC), a field-programmable gate array (FPGA), or other customized device. Moreover, those of ordinary skill in the art and others will recognize that the computational device can be any one of any number of currently available or yet to be developed devices.

In its most basic configuration, a computational device includes at least one processor and a system memory connected by a communication bus. Depending on the exact configuration and type of device, the system memory can be volatile or nonvolatile memory, such as read only memory (“ROM”), random access memory (“RAM”), EEPROM, flash memory, or similar memory technology. Those of ordinary skill in the art and others will recognize that system memory typically stores data and/or program modules that are immediately accessible to and/or currently being operated on by the processor. In this regard, the processor can serve as a computational center of the computational device by supporting the execution of instructions.

A computational device can include a network interface comprising one or more components for communicating with other devices over a network. Embodiments of the present disclosure can access basic services that utilize the network interface to perform communications using common network protocols. The network interface can also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface can represent one or more wireless interfaces or physical communication interfaces described and illustrated above with respect to particular components of the computational device.

The computational device also includes a storage medium. However, services can be accessed using a computational device that does not include means for persisting data to a local storage medium. Therefore, the storage medium can be optional. In any event, the storage medium can be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computational devices that include a processor, system memory, communication bus, storage medium, and network interface are known and commercially available. For case of illustration and because it is not important for an understanding of the claimed subject matter, the disclosure does not show some of the typical components of many computational devices. In this regard, the computational device can include input devices, such as a keyboard, keypad, mouse, microphone, touch input device, touch screen, tablet, and/or the like. Such input devices can be coupled to the computational device by wired or wireless connections including RF, infrared, serial, parallel, Bluetooth, Bluetooth low energy, USB, or other suitable connections protocols using wireless or physical connections. Similarly, the computational device can also include output devices such as a display, speakers, printer, and the like. Since these devices are well known in the art, they are not illustrated or described further herein.

The principles, example embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

### NON-LIMITING EMBODIMENTS

While general features of the disclosure are described and shown and particular features of the disclosure are set forth in the claims, the following non-limiting embodiments relate to features, and combinations of features, that are explicitly envisioned as being part of the disclosure. The following non-limiting Embodiments contain elements that are modular and can be combined with each other in any number, order, or combination to form a new non-limiting Embodiment, which can itself be further combined with other non-limiting Embodiments.

Embodiment 1. A pneumatic conveyer system configured for controlled mixture and conveyance of a plurality of formulations that comprises a non-fluid formulation, the pneumatic conveyer system comprising: an air compressor configured to intake air and pump pressurized air into a Venturi channel; a plurality of formulation conduits that are fluidically connectable to the plurality of formulations and are fluidically connected to the Venturi channel, wherein connection of the plurality of formulation conduits to the plurality of formulations and passage of air from the air compressor into the Venturi channel draws the plurality of formulations into the Venturi channel such that the non-fluid formulation is mixed with a fluid formulation and the air to form an aerated mixture; and an air separator configured to degas the aerated mixture to form a non-aerated mixture and convey the non-aerated mixture therefrom.

Embodiment 2. The pneumatic conveyer system of Embodiment 1 or any other Embodiment, wherein the air compressor intakes environmental air through an intake vent and wherein the air separator exhausts air through an exhaust vent, and the air compressor pumps pressurized air into the Venturi channel by way of an air conduit.

Embodiment 3. The pneumatic conveyer system of any one of Embodiments 1-2 or any other Embodiment, wherein the air separator is a cyclone air separator configured to separate air from the aerated mixture by way of vortex separation.

Embodiment 4. The pneumatic conveyer system of any one of Embodiments 1-3 or any other Embodiment, further comprising a plurality of dampers operably connected to control circuitry and configured for control of flow of the plurality of formulations therethrough for production of the aerated mixture from the plurality of formulations based on a mix ratio for the plurality of formulations.

Embodiment 5. The pneumatic conveyer system of any one of Embodiments 1-3 or any other Embodiment, wherein the control circuitry is configured to receive one or more signals from one or more formulation cartridges that corresponds to one or more formulations of the plurality of formulations, and compute the mix ratio based on the one or more signals.

Embodiment 6. The pneumatic conveyer system of any one of Embodiments 1-5 or any other Embodiment, wherein the mix ratio defines a relative amount of the non-fluid formulation to be mixed with a relative amount of the fluid formulation to form the aerated mixture.

Embodiment 7. The pneumatic conveyer system of any one of Embodiments 1-6 or any other Embodiment, wherein the non-fluid formulation is a powder.

Embodiment 8. The pneumatic conveyer system of any one of Embodiments 1-7 or any other Embodiment, wherein the powder and the fluid formulation are components of a hair bleach composition for bleaching hair of an individual.

Embodiment 9. The pneumatic conveyer system of any one of Embodiments 1-8 or any other Embodiment, wherein the air separator conveys the non-aerated mixture to a formulation mixer that mixes and homogenizes the non-aerated mixture, and is configured to dispense a resultant formulation through a reciprocating nozzle assembly to be applied to hair of an individual.

Embodiment 10. The pneumatic conveyer system of any one of Embodiments 1-9 or any other Embodiment, wherein the formulation mixer is a turbulent mixing chamber that comprises one or more helical mixers positioned within a fluidic pathway and configured to carry, mix, and homogenize the non-aerated mixture to produce the resultant formulation.

Embodiment 11. The pneumatic conveyer system of any one of Embodiments 1-10 or any other Embodiment, wherein the reciprocating nozzle assembly comprises a plurality of nozzles and is driven by a motor, such that the plurality of nozzles reciprocate back-and-forth along a track while dispensing the resultant formulation.

Embodiment 12. The pneumatic conveyer system of any one of Embodiments 1-11 or any other Embodiment, wherein the passage of air from the air compressor into the Venturi channel produces a vacuum that draws at least a portion of the plurality of formulations into the Venturi channel based on configurations of a plurality of dampers configured for control of flow of the plurality of formulations therethrough.

Embodiment 13. The pneumatic conveyer system of any one of Embodiments 1-13 or any other Embodiment, wherein the Venturi channel comprises an air conduit at a central portion thereof, a first formulation conduit at a first portion thereof configured to carry a first formulation of the plurality of formulations, and a second formulation conduit at a second portion thereof configured to carry a second formulation of the plurality of formulations, wherein the central portion is positioned between the first portion and second portion.

Embodiment 14. The pneumatic conveyer system of any one of Embodiments 1-13 or any other Embodiment, wherein a first damper is positioned inline with the first formulation conduit and a second damper is positioned inline with the second formulation conduit, wherein the first damper and second damper are positioned upstream of the air separator.

Embodiment 15. A formulation delivery device or formulation delivery system comprising the pneumatic conveyer system of any one of Embodiments 1-14 or any other Embodiment.

While illustrative embodiments have been illustrated and described, it will be appreciated that various changes can be made therein without departing from the spirit and scope of the disclosure.

1. A pneumatic conveyer system configured for controlled mixture and conveyance of a plurality of formulations that comprises a non-fluid formulation, the pneumatic conveyer system comprising:
an air compressor configured to intake air and pump pressurized air into a Venturi channel;
a plurality of formulation conduits that are fluidically connectable to the plurality of formulations and are fluidically connected to the Venturi channel, wherein connection of the plurality of formulation conduits to the plurality of formulations and passage of air from the air compressor into the Venturi channel draws the plurality of formulations into the Venturi channel such that the non-fluid formulation is mixed with a fluid formulation and the air to form an aerated mixture; and
an air separator configured to degas the aerated mixture to form a non-aerated mixture and convey the non-aerated mixture therefrom.

2. The pneumatic conveyer system of claim 1, wherein the air compressor intakes environmental air through an intake vent and wherein the air separator exhausts air through an exhaust vent, and the air compressor pumps pressurized air into the Venturi channel by way of an air conduit.

3. The pneumatic conveyer system of claim 1, wherein the air separator is a cyclone air separator configured to separate air from the aerated mixture by way of vortex separation.

4. The pneumatic conveyer system of claim 1, further comprising a plurality of dampers operably connected to control circuitry and configured for control of flow of the plurality of formulations therethrough for production of the aerated mixture from the plurality of formulations based on a mix ratio for the plurality of formulations.

5. The pneumatic conveyer system of claim 4, wherein the control circuitry is configured to receive one or more signals from one or more formulation cartridges that corresponds to one or more formulations of the plurality of formulations, and compute the mix ratio based on the one or more signals.

6. The pneumatic conveyer system of claim 4, wherein the mix ratio defines a relative amount of the non-fluid formulation to be mixed with a relative amount of the fluid formulation to form the aerated mixture.

7. The pneumatic conveyer system of claim 1, wherein the non-fluid formulation is a powder.

8. The pneumatic conveyer system of claim 7, wherein the powder and the fluid formulation are components of a hair bleach composition for bleaching hair of an individual.

9. The pneumatic conveyer system of claim 1, wherein the air separator conveys the non-aerated mixture to a formulation mixer that mixes and homogenizes the non-aerated mixture, and is configured to dispense a resultant formulation through a reciprocating nozzle assembly to be applied to hair of an individual.

10. The pneumatic conveyer system of claim 9, wherein the formulation mixer is a turbulent mixing chamber that comprises one or more helical mixers positioned within a fluidic pathway and configured to carry, mix, and homogenize the non-aerated mixture to produce the resultant formulation.

11. The pneumatic conveyer system of claim 9, wherein the reciprocating nozzle assembly comprises a plurality of nozzles and is driven by a motor, such that the plurality of nozzles reciprocate back-and-forth along a track while dispensing the resultant formulation.

12. The pneumatic conveyer system of claim 1, wherein the passage of air from the air compressor into the Venturi channel produces a vacuum that draws at least a portion of the plurality of formulations into the Venturi channel based on configurations of a plurality of dampers configured for control of flow of the plurality of formulations therethrough.

13. The pneumatic conveyer system of claim 12, wherein the Venturi channel comprises an air conduit at a central portion thereof, a first formulation conduit at a first portion thereof configured to carry a first formulation of the plurality of formulations, and a second formulation conduit at a second portion thereof configured to carry a second formulation of the plurality of formulations, wherein the central portion is positioned between the first portion and second portion.

14. The pneumatic conveyer system of claim 13, wherein a first damper is positioned inline with the first formulation conduit and a second damper is positioned inline with the second formulation conduit, wherein the first damper and second damper are positioned upstream of the air separator.

15. A formulation delivery device or formulation delivery system comprising the pneumatic conveyer system of claim 1.
